(19) United States
(12) Patent Application Publication
(10) Pub. No.: US 2008/0300953 A1
(43) Pub. Date: Dec. 4, 2008

(54) Workforce management system with fairness scheduling

(75) Inventor: John David Sarlay, Dallas, TX (US)

Correspondence Address: LAW OFFICE OF DAVID H. JUDSON, 15950 DALLAS PARKWAY, SUITE 225, DALLAS, TX, 75248, US

(73) Assignee: IEX CORPORATION, Richardson, TX (US)

(21) Appl. No.: 11/757,794

(22) Filed: Jun. 4, 2007

(51) Int. Cl. G06Q 50/00

(52) U.S. Cl. 705/9

(57) ABSTRACT

A workforce management system implements enhanced any-day-of-the-week or holiday fairness processing. The system provides one or more display interfaces indexed by day of week or given holiday dates, and through which a user defines a fairness policy with respect to each such day or dates. In use, the system compares a fairness policy with historical credit data to generate a rank order of agent eligibility to fulfill a contact center schedule for a given day or holiday date. This rank order of agent availability is then provided to a scheduler to enable generation of one or more contact center schedules for the given day or holiday date. The day of week and holiday fairness may be carried out independently or combined. The system also enables fairness days or dates to be processed according to a user-defined priority.

### COPYRIGHT STATEMENT

This application includes subject matter that is protected by copyright. All rights are reserved.

### BACKGROUND OF THE INVENTION

1. Technical Field

The present invention relates generally to computer-implemented agent or employee scheduling in a work center environment.

2. Background of the Related Art

Workforce management systems are well-known in the prior art. Such systems integrate many management functions, such as workforce forecasting and scheduling, skill planning and scheduling, multimedia contact management, real-time schedule adherence, and the like. A representative commercial system of this type is TotalView® workforce management, from IEX Corporation.

Managing time off requests quickly and fairly can be a huge administrative task for contact centers. Every decision can directly impact operational costs and affect employee morale. It is known in the prior art to provide a workforce management system with a vacation and holiday planning module that allows employees to have more control over their scheduled time off, and that enables a system administrator to streamline vacation and holiday planning using objective, rules-based approvals. Time off rules determine how many agents can take time off on a given day, whether partial-day time off is allowed, and date ranges for which time off can be requested. Time off rules can be unique for different areas of the contact center, so that certain skills, shifts or sites can manage the availability of time off independently. Typically, agents or supervisors access display screens on designated workstations to make or modify selections. Once vacation time is approved, the system automatically includes granted vacation time when creating schedules. By integrating vacation data into its schedule generation process, the contact center does not compromise service levels or risk being understaffed.

It is also known in the art to implement fair, automatic work assignment rotations for a set of agents by taking into account their previous work history on so-called “fairness” days. Thus, within the contact center environment, weekend days (e.g., Saturday, Sunday, or Saturday-Sunday) sometimes are identified as “fairness” days, as such days typically reflect days that most agents might prefer not to work (although, of course, other agents might want to work such days for higher pay, or other reasons). An agent who ends up being scheduled to work a fairness day is given a credit for that day, and fairness day credit history is maintained by the system. When it is necessary to schedule agents for subsequent fairness days, such systems may rank order the available pool of agents by taking credits and other information into account. Thus, for example, if more agents volunteer for a fairness day than are required, then the most senior agents typically are selected (honoring other selection restrictions and processing). If fewer agents volunteer than are required, however, then the least senior agents are selected (honoring other selection restrictions and processing).

While workforce management system fairness processing provides significant advantages, there is a desire to provide enhancements to such techniques.

### BRIEF SUMMARY OF THE INVENTION

A workforce management system implements fairness processing. In one embodiment, the system provides one or more display interfaces indexed by day of week or given holiday dates, and through which a user defines a fairness policy with respect to each such day or dates. In use, the system compares a fairness policy with historical credit data to generate a rank order of agent eligibility to fulfill a contact center schedule for a given day or holiday date. This rank order of agent availability is then provided to a scheduler to enable generation of one or more contact center schedules for the given day or holiday date. The day of week and holiday fairness may be carried out independently, or in a combined manner (wherein holiday dates override day of week fairness processing). The system also enables fairness days or dates to be processed according to a user-defined priority.

In another embodiment, a workforce management system implements enhanced any-day-of-the-week or weekend fairness processing. To this end, the system provides a display interface indexed by any day of the week or weekend and through which a user defines an any-day-of-the-week or weekend fairness policy. Preferably, the day of the week or weekend fairness policy is associated with one or more user-defined sort options that order agents (a) when there are not enough volunteers to meet a number of agents required to work, or (b) when there are more volunteers than there are agents needed to meet requirements. In use, the system compares a day of the week or weekend fairness policy with historical credit data to generate a rank order of agent eligibility to fulfill a contact center schedule for a given day of the week or weekend. This rank order of agent availability is then provided to a scheduler to enable generation of one or more contact center schedules for the given day of the week or weekend.

In another embodiment, a workforce management system implements holiday fairness processing. To this end, the system provides a display interface indexed by holiday and through which a user defines a holiday fairness policy. Preferably, the holiday fairness policy is associated with one or more user-defined sort options that order agents (a) when there are not enough volunteers to meet a number of agents required to work, or (b) when there are more volunteers than there are agents needed to meet requirements. In use, the system compares a holiday fairness policy with historical credit data to generate a rank order of agent eligibility to fulfill a contact center schedule for a given holiday. This rank order of agent availability is then provided to a scheduler to enable generation of one or more contact center schedules for the given holiday.

As noted above, the day-of-the-week and holiday fairness processing may be combined. Thus, for example, if a holiday date (as a given day of the week) is marked as using fairness, then preferably day of week or weekend fairness is not processed for this date (i.e. the holiday fairness takes precedence or overrules the day of week or weekend fairness rotation). Moreover, when determining whether agents worked a day of the week or weekend, if the date was a holiday that used fairness, such date is not considered for the day of week or weekend fairness rotation.

According to another feature of the invention, fairness days may be processed in a priority order, which may be designated by the agent. More than one day may have the same priority order, in which case the days are processed together as a group. For each fairness priority value, preferably the schedule generation process determines which agent will work the fairness days in that group and which agents will be scheduled off. When a subsequent priority value is being processing, the schedule generation process preferably does not alter the fairness assignments of fairness days with a higher priority.

The foregoing has outlined some of the more pertinent features of the invention. These features should be construed to be merely illustrative. Many other beneficial results can be attained by applying the disclosed invention in a different manner or by modifying the invention as will be described.

### BRIEF DESCRIPTION OF THE DRAWINGS

For a more complete understanding of the present invention and the advantages thereof, reference is now made to the following descriptions taken in conjunction with the accompanying drawings, in which:

FIG. 1 is an illustrative workforce management center in which the present invention may be implemented;

FIG. 2A illustrates a first portion of an administrator display tab for use in setting a day of week or weekend fairness policy;

FIG. 2B illustrates a second portion of the administrator display tab for use in setting the day of week or weekend fairness policy;

FIG. 2C illustrates a third portion of the administrator display tab for use in setting the day of week or weekend fairness policy;

FIG. 2D illustrates the administrator display tab of FIG. 1A when a weekend processing row is selected;

FIG. 3A illustrates a first portion of an administrator display tab for use in setting a holiday fairness policy;

FIG. 3B illustrates a second portion of the administrator display tab for use in setting a holiday fairness policy;

FIG. 3C illustrates a third portion of the administrator display tab for use in setting a holiday fairness policy;

### DETAILED DESCRIPTION OF AN ILLUSTRATIVE EMBODIMENT

In the following discussion, the invention is described in the context of a contact center environment, although it should be understood that the invention can be practiced in other types of environments such as, without limitation, sales force environments, field service environments, manufacturing environments, airports, airlines, government agencies, casinos, banks, retail stores, warehouses, and other types of environments wherein entities (agents, employees, contractors, other persons, or the like) work according to assigned schedules. In a contact center, the environment generally comprises an automatic call distributor (ACD), and one or more multimedia server(s) coupled to a host computer via a computer network. The ACD is coupled to a communications network. The ACD and multimedia server(s) generally provide routing capabilities for incoming voice calls (via the ACD) and other contacts (via the multimedia server), such as faxes, email, voice mail, web requests, web call-back requests, web chats, web voice calls, web video calls, and the like. For ease of discussion, the persons who work at the contact center are referred to herein variously as “agents” or “employees.” These designations are used interchangeably within the following description. Of course, this nomenclature is not meant to be taken to limit the invention in any way, as the word “employee” or the word “agent” is meant to be broadly construed to include any person regardless of a particular legal status. An entity need not actually handle contacts, of course. A “schedule” is any ordered list of times at which given events or activities are planned to occur.

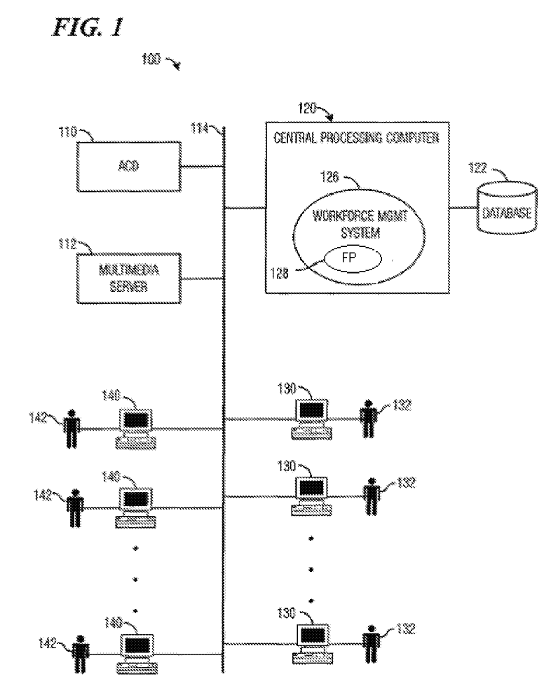

Referring to FIG. 1, the reference numeral 100 generally designates a workforce contact center environment. As noted above, the environment 100 generally comprises an automatic call distributor (ACD) 110 and a multimedia server 112 coupled to a central processing computer 120 via a network 114, such as a wireline and/or wireless local area network (LAN), a wireline and/or wireless wide area network (WAN), the Internet, an Intranet, or the like. As also described above, the ACD 110 and multimedia server 112 generally provide routing capabilities for incoming voice calls (via the ACD) and other contacts (via the multimedia server). The function and operation of the ACD 110 and multimedia server 112 are considered to be well-known to a person having ordinary skill in the art. The central processing computer 120 receives from the ACD 110 and the multimedia server 112 periodic contact information, such as the number of contacts handled (“in contacts”), the amount of time an agent spends on incoming contacts (“talk time”), the amount of time an agent spends after the talk time for administrative duties related to contact resolution (“work time”), the amount of time an agent spends in talk time and work time (“total time), the amount of time an agent spends available to take a call (“available time”), the amount of time an agent spends in an auxiliary state and/or is unable to take a call (“aux time” and/or “break time”), the number of outgoing contacts made by the agent (“out contacts”), the time spent on the outgoing contacts (“out time”), the elapsed time spent logged into the service system (“system time”), and the like, and preferably stores the information in a database 122 coupled to the central processing computer 120, preferably at 15-30 minute intervals or real time. A workforce management system 126 provides workforce forecasting and scheduling, skill planning and scheduling, multimedia contact management, real-time schedule adherence, and the like. While the database 122 is shown external to the computer, one skilled in the art will appreciate that the database 122 may be included within the central processing computer 120, or that the data be retrieved from any other location when needed. The central processing computer 120 is also coupled via the network 114 to one or more agent workstations 130 and to one or more supervisor workstations 140, which provide an interface between the network 114 and one or more agents 132 and supervisors 142, respectively. The agent workstations 130 and the supervisor workstations 140 are preferably configured to access the central processing computer 120 through the network 114 via a browser, such as a Java-enabled web browser. As is well-known, agents 132 access, via the telephone (not shown) and agent workstation 130, the ACD 110, multimedia server 112, or other contact servers (not shown) to aid in contact resolution. As the agents 132 service the contacts, the ACD 110 and the multimedia server 112 collect performance and other data for each of the agents 132. The performance data of the agents 132, such as the in contacts, talk time, work time, total time, available time, aux time, out contacts, out time, system time, and the like, are sent periodically by the ACD 110 and the multimedia server 112 to the central processing computer 120 and, preferably, stored in the database 122.

The workforce management system (WMS) 126 is a suite of one or more software-driven systems that provide workforce forecasting and scheduling, skill planning and scheduling, multimedia contact management, real-time schedule adherence, and the like, and that provides an interface to the database 122. A representative commercial system of this type is TotalView® workforce management, from IEX Corporation. The workforce management system typically includes a holiday and vacation planning module that implements fairness processing 128 in a known manner. In particular, the module enables a system administrator (such as a work supervisor) the ability to streamline vacation and holiday planning using objective, rules-based approvals. Time off rules determine how many agents can take time off on a given day, whether partial-day time off is allowed, and date ranges for which time off can be requested. Time off rules can be unique for different areas of the contact center, so that certain skills, shifts or sites can manage the availability of time off independently. Agents or supervisors access display screens on designated workstations to make or modify selections. Once vacation time is approved, the system automatically includes granted vacation time when creating schedules. The fairness processing 128 is a known function. In particular, as described above, it is known in the art to implement fair, automatic work assignment rotations for a set of agents by taking into account their previous work history on so-called “fairness” days. Thus, within the contact center environment, various days (e.g., a weekend) are identified as “fairness” days, as such days typically reflect days that most agents might prefer not to work. An agent who ends up being scheduled to work (and does work) a fairness day is given a credit for that day, and fairness day credit history is maintained by the system in database 122. When it is necessary to schedule agents for subsequent fairness days, the fairness processing function 128 rank orders the available pool of agents, e.g., by taking credits and other information into account. Thus, for example, if more agents volunteer for a fairness day than are required, then the most senior agents typically are selected (honoring other selection restrictions and processing). If fewer agents volunteer than are required, however, then the least senior agents are selected (honoring other selection restrictions and processing).

More generally, a workforce management system environment in which the method and system of the invention may be implemented includes a set of computing-related entities (systems, machines, processes, programs, libraries, functions, or the like) that facilitate or provide an agent-supervisor network. In a typical implementation, the environment typically comprises a set of computers. A representative machine is a client workstation or a network-based server running commodity (e.g. Pentium-class) hardware, an operating system (e.g., Linux, Windows 2000, OS-X, or the like), an application runtime environment (e.g., Java), and a set of applications or processes (e.g., Java applets or servlets, linkable libraries, native code, or the like, depending on platform) that provide the functionality of a given system or subsystem. A client machine typically includes a Web browser (Internet Explorer, Netscape Navigator, Apple Safari, or the like) or other rendering engine. A Web browser typically includes or supports media players and other plug-ins. Conveniently, information may be provided on an agent workstation using a Java-based applet or application.

It is further noted that, unless indicated otherwise, all functions described herein may be performed in either hardware or software, or any combination thereof. In a preferred embodiment, the functions are performed by one or more processors executing given software.

Generally, the present invention comprises a number of embodiments. In a first embodiment, the workforce management system implements any-day-of-the-week or weekend fairness processing. To this end, and as will be seen, in one embodiment, the system provides a display interface indexed by any day of the week or weekend and through which a user defines an any-day-of-the-week or weekend fairness policy. Preferably, the day of the week or weekend fairness policy is associated with one or more user-defined sort options that order agents (a) when there are not enough volunteers to meet a number of agents required to work, or (b) when there are more volunteers than there are agents needed to meet requirements. The word “volunteers” should not be taken to limit the invention. In use, the system compares a day of the week or weekend fairness policy with historical credit data to generate a rank order of agent eligibility to fulfill a contact center schedule for a given day of the week or weekend. This rank order of agent availability is then provided to a scheduler to enable generation of one or more contact center schedules for the given day of the week or weekend.

Fairness processing allows the contact center manager to set up days to be considered as fairness days and to set up rules to govern which agents will be scheduled for those days. Agents may optionally indicate a preference to work on a fairness day or may indicate a desire to be scheduled off for a fairness day. As noted above, preferably the rules can be configured such that different processing occurs depending on whether more agents have volunteered to work than are needed, or whether fewer agents have volunteered to work than are needed. If the required number of agents exceeds the number of agents who volunteered to work, then the system will choose which agents should be scheduled in addition to the volunteers. The agents selected can be based on numerous factors, including which agents worked most recently, which agents have worked more fairness days than other agents and various seniority and ranking orders of the agents. If the number of volunteers exceeds the number of agents required to work, then the system will limit which agents will be scheduled from the pool of volunteers. The agents selected from this pool will be based on the same factors detailed above, but ordered independently from the sort order above.

As an example, Saturday in general may be designated as a fairness day. Agents may volunteer to work on Saturdays, perhaps because a pay differential makes working on Saturday more attractive than a week day. If not enough agents volunteer, then some agents who desired to be scheduled off, will in fact need to work. The sort order might be configured to first look at agents who least recently worked on a Saturday. A second sort order might then be used as a tie-breaker, such as considering how many times each agent has worked on a Saturday (credits may include days actually worked by agents as well as a user-supplied value); agents who have worked the fewest Saturdays are higher in the list for selection to work. A third tie-breaker sort order may be defined such as rank; the lower-ranked agents are higher in the list for selection to work.

As another example, if more agents volunteered to work Saturday than were needed, the system will limit which agents are scheduled. An initial sort order might be to first look at agents who have worked the fewest number of Saturdays. A second sort order tie-breaker might be to consider all fairness days and choose agents with the fewest credits from all fairness days (not just Saturdays). A third sort order tie-breaker might again be the rank order of agents (this user-defined order of agents is sometimes this is based on hire date, sometimes based on performance, sometimes a combination of several factors).

In a second embodiment, the workforce management system implements “holiday fairness” processing. A particular holiday is associated with a date or dates (such as Thanksgiving, or Thanksgiving and the following Friday). To this end, the system provides a display interface indexed by holiday and through which a user defines a holiday fairness policy. Preferably, the holiday fairness policy is associated with one or more user-defined sort options that order agents (a) when there are not enough volunteers to meet a number of agents required to work, or (b) when there are more volunteers than there are agents needed to meet requirements. In use, the system compares a holiday fairness policy with historical credit data to generate a rank order of agent eligibility to fulfill a contact center schedule for a given holiday. This rank order of agent availability is then provided to a scheduler to enable generation of one or more contact center schedules for the given holiday.

In a third embodiment, the day of week and holiday fairness functions, which may operate independently of one another, are integrated.

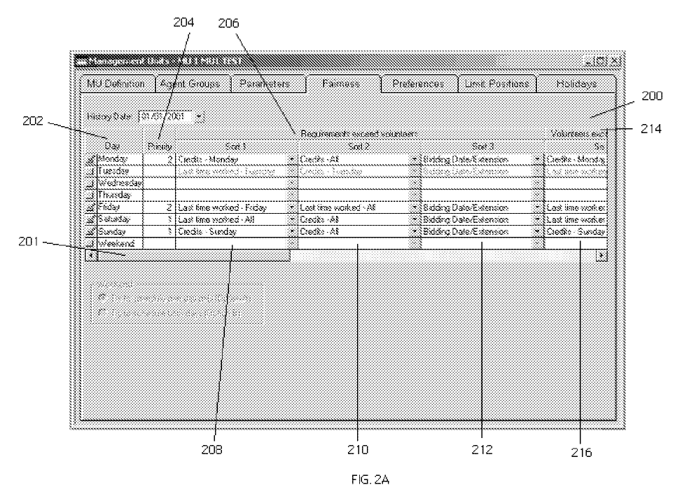

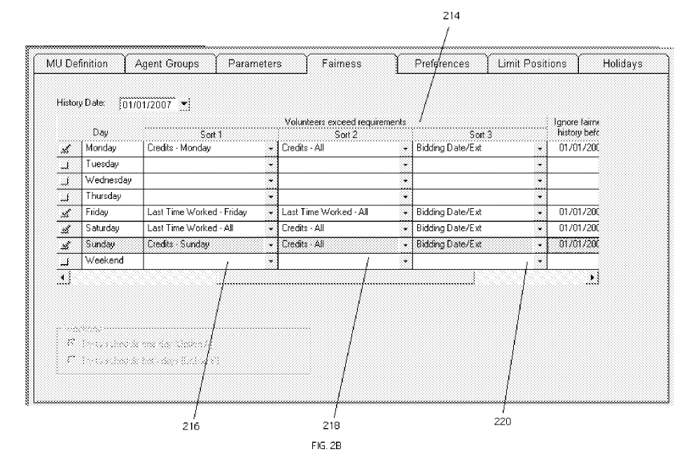

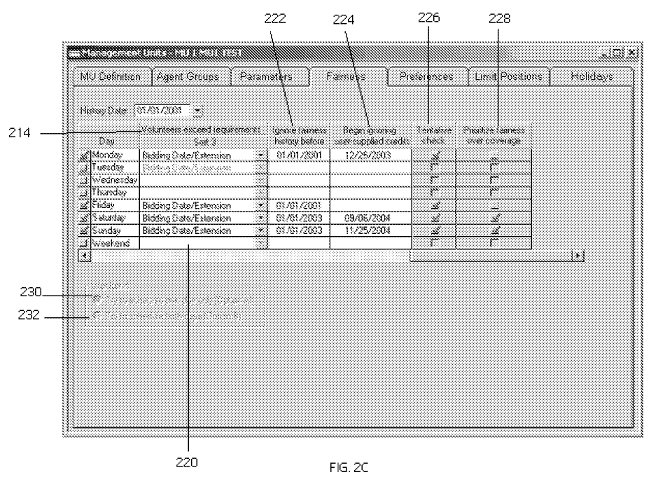

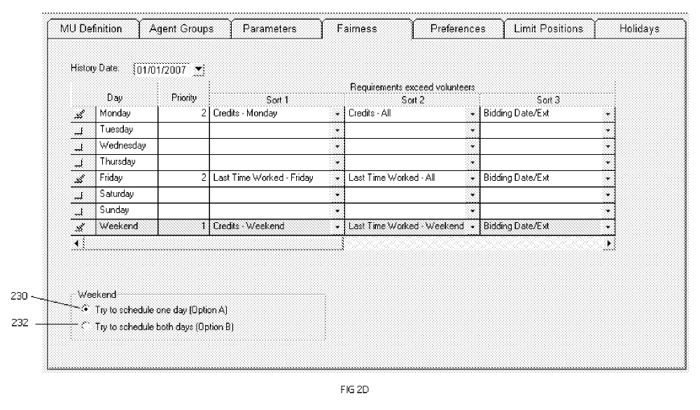

FIG. 2A illustrates a first portion of an administrator display tab 200 by which day of week fairness processing may be configured. FIG. 2B illustrates a second portion of the administrator display tab, and FIG. 2C illustrates a third portion thereof. In this example, the display tab 200 is associated with a given management unit (MU), although this is not a requirement of the invention. In particular, and as described in U.S. Pat. No. 6,970,829, which patent is commonly-owned and incorporated herein by reference, typically a management unit is a collection of agents located at a particular contact center location (e.g., a site or floor within a multi-story site). A day of the week fairness processing display tab (such as shown) also may be associated with a given contact type. A “contact type” is a queue or a collection of queues. As described in the above-identified patent, an MU typically is associated with more than one contact type for purposes of skills-based planning and scheduling.

The respective portions are accessed using a scrollbar 201 as indicated. As seen in FIG. 2A, the tab 200 preferably comprises a data entry table having a number of rows and columns. A “day” column 202 identifies each day of week and a “weekend.” The individual row can be checked or unchecked to indicate that the day (or weekend), as the case may be, should be considered for fairness processing. A “priority” column 204 is used to indicate a priority level of each fairness day (or weekend). Typical values are integers, and multiple days may have the same priority level. If fairness days do not all have the same priority, then it is possible that coverage may be negatively impacted, as the use of priorities gives preferential treatment to higher-prioritized fairness days. A “Requirements exceed volunteers” column 206 preferably includes a set of “sort” sub-columns, e.g., Sort 1 (reference numeral 208), Sort 2 (reference numeral 210), and Sort 3 (reference numeral 212). The various sort options allows the user to indicate a first sort option, a second sort option, a third sort option, and so on, for ordering agents when choosing which agent is most eligible to work the particular day of the week (or weekend), when there are not enough volunteers to meet the number of agents needed to work. The sorts are used in order for tie-breaking purposes. Thus, Sort 1 will be preferred, followed by Sort 2, followed by Sort 3, and so on. It is not required to have three (3) sort (tie-breaker) levels, of course. The sort options (available from the drop down list) in each sub-column preferably include: (none), Bidding Date/Extension, Seniority Date/Extension, Rank, Credits—<day>, Credits—All, Last Time Worked—<day>, Last Time Worked—All <where <day> is Monday through Sunday or “Weekend” depending on the row. The “Credits—<day>” option enables the user to sort based on the number of credits for the specific day identified, whereas the Credits—All” option counts the credits from all days marked as using fairness. An “Extension” typically is some form of bidding tie breaker that may be set by the administrator or system. It should be appreciated that a credit typically is counted only where the agent actually worked on the fairness day previously, although it may also include tentative days (one or more days that the agent intends to work in the future) that will occur prior to the day being scheduled. Likewise, the “Last Time Worked” option is expanded to allow the user to indicate whether the last time the agent worked this day is considered (namely, the Last Time Worked—<day> option), or the last time the agent worked any day which is marked as a fairness day (the Last Time Worked—All option). Preferably, the Credits—All and Last Time Worked—All options refer only to weekday/weekend records, and not to holiday records.

Moving horizontally, as shown in FIG. 2B and then FIG. 2C, the display tab 200 also includes a “Volunteers exceed requirements” column 214, once again preferably with three (3) sub-columns for Sort 1 (sub-column 216), Sort 2 (sub-column 218) and Sort 3 (sub-column 220). Each sub-column preferably also includes a similar drop down list. The “Volunteers exceed requirements” column allows the user to indicate a first sort option, a second sort option, a third sort option, and so on, for ordering agents when choosing which agent is most eligible to work this day of the week (or “weekend”) when there are more volunteers than there are agents need to meet requirements. As best seen in FIG. 2C, a column 222 enables the user to identify fairness history records that will be ignored in the fairness process by setting a date. A column 224 enables the user to identify a start date at which the fairness algorithm should begin ignoring user-supplied credits. A user-supplied credit enables the administrator to compensate for the varying times at which given employees begin working for the organization. Without them, a fairness policy might prejudice a newly hired agent, who would otherwise have few or perhaps no credits. If “Credits—Type” or “Credits—All” is selected as a sort option (as described above), this date indicates that the user-supplied credit value should not be used when generating schedules for this date or later. As also seen in FIG. 2C, a “Tentative” check column 226 (as noted above) allows the user to specify whether an agent who is scheduled for a future same day of the week (or weekend) will be given credit for “working” that day (if that day occurs before the day being scheduled). Finally, a “Prioritize fairness over coverage” column 228 (FIG. 2C) allows the user to specify (by checking the associated box) that fairness rotations should be strictly honored, despite coverage needs.

A display tab may also include a pair of radio buttons 230 and 232 that are enabled when weekend processing (the weekend row) is selected. This operation is shown in FIG. 2D. In particular, the “Try to schedule day only” option 230 indicates that the schedule generator should attempt to schedule agents for only one of the weekend days (Saturday, or Sunday). If the “Try to schedule both days” option 232 is selected, the schedule generator attempts to schedule an agent for both of the weekend days if the agent is scheduled for either day. This feature is advantageous as it attempts to maximize the number of weekends the agent is actually scheduled off.

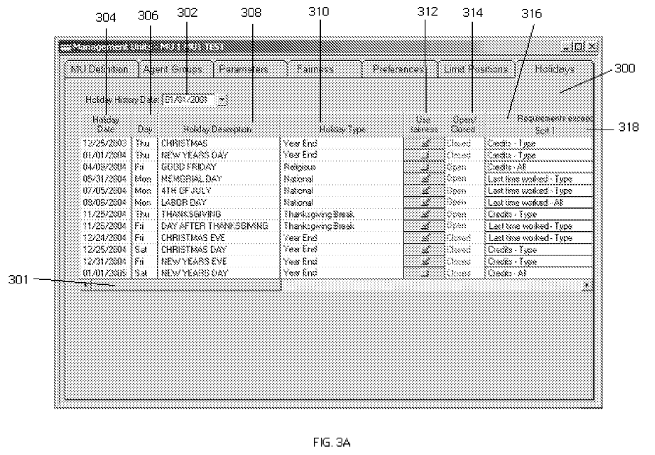

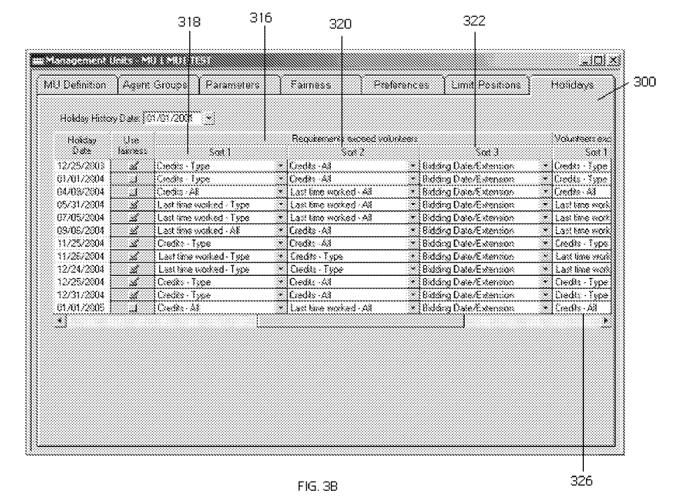

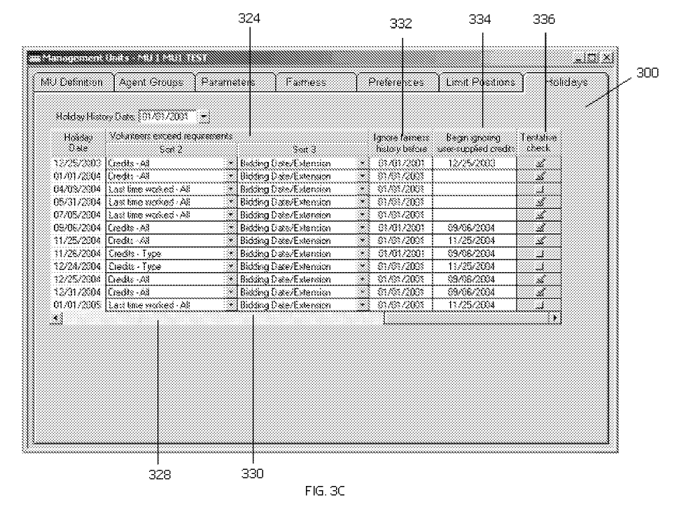

FIG. 3A illustrates a first portion of an administrator display tab 300 by which holiday fairness processing may be configured. FIG. 3B illustrates a second portion of the administrator display tab, and FIG. 3C illustrates a third portion thereof. The respective first, second and third portions preferably are accessed using a scrollbar 301 as indicated. As seen in FIG. 3A, the tab 300 preferably comprises a data entry table having a number of rows and columns. A Holiday History Date drop down list box 302 enables the user to identify an earliest date for which to consider holiday history. A “Holiday Date” column 304 identifies the holidays that are capable of being defined as “Open” or “Closed” for the retrieved management unit shown in the display tab. As noted above, the MU-specific fairness processing is not a requirement of the present invention. A “Day” column 306 indicates the day of the week corresponding to the Holiday Date. A “Holiday Description” column 308 provides a description corresponding to the Holiday Date, and the “Holiday Type” column 310 provides an associated type. A “Use fairness” column 312 includes a checkbox for each holiday that allows the user to indicate if holiday fairness processing should be done during schedule generation. An “Open/Closed” column 314 indicates if the MU observes the holiday as “Open” or “Closed.” Now, moving horizontally into FIG. 3B, the display tab 300 preferably includes a “Requirements exceed volunteers” column 316. As described above in the day of week fairness configuration screen, preferably this column includes a set of “sort” sub-columns, e.g., Sort 1 (reference numeral 318), Sort 2 (reference numeral 320), and Sort 3 (reference numeral 322). Once again, the various sort options allows the user to indicate a first sort option, a second sort option, a third sort option, and so on, for ordering agents when choosing which agent is most eligible to work this holiday, when there are not enough volunteers to meet the number of agents needed to work. The sorts are used in order for tie-breaking purposes. Thus, Sort 1 will be preferred, followed by Sort 2, followed by Sort 3, and so on. It is not required to have three (3) sort (tie-breaker) levels, of course. The sort options (available from the drop down list) in each sub-column preferably include: (none), Bidding Date/Extension, Seniority Date/Extension, Rank, Credits—Type, Credits—All, Last Time Worked—Type, Last Time Worked—All. With the “Credits—Type” option selected, the sort algorithm only reviews the credit records that are of this particular holiday type. With “Credits—All” selected, the algorithm looks at all holiday credit records. Preferably, in neither case does the routine look at weekday (or weekend) credit records. The “Last Time Worked—Type” option reviews only the holiday history for dates that are of this particular holiday type, whereas the “Last Time Worked—All” option considers all holiday credit records. Once again, preferably weekday (or weekend) credit records are ignored during this processing.

Moving horizontally into FIG. 3C, the display tab preferably also includes a “Volunteers exceed requirements” column 324, once again preferably with three (3) sub-columns for Sort 1 (sub-column 326), Sort 2 (sub-column 328) and Sort 3 (sub-column 330). Each sub-column preferably also includes a similar drop down list. The “Volunteers exceed requirements” column allows the user to indicate a first sort option, a second sort option, a third sort option, and so on, for ordering agents when choosing which agent is most eligible to work this holiday when there are more volunteers than there are agents need to meet requirements. As in the day of week embodiment, a column 332 enables the user to identify fairness history records that will be ignored in the fairness process by setting a date. A column 334 enables the user to identify a start date at which the fairness algorithm should begin ignoring user-supplied credits. In particular, if “Credits—Type” or “Credits—All” is selected as a sort option, this date indicates that the user-supplied credit value should not be used when generating schedules for this date or later. Finally, a “Tentative” check column 336 allows the user to specify whether an agent who is scheduled for a future holiday date will be given credit for working that date when that date is prior to the date being scheduled.

As can be seen, by using the display tab shown in FIGS. 2A and 2B, the day of week fairness processing is configurable with several fairness options. In particular, day of week fairness policy can be configured for Monday through Friday, as well as for a Weekend. Moreover, various sort options may be configured and honored for each selected day (or weekend), and each fairness day may have a different option. The sub-columns allow the user to select several (in this embodiment, up to three (3)) sort options if there are more agents needed than the number who volunteered, and up to three (3) sort options if there are more volunteers than the number of agents needed. Moreover, instead of just counting “Credits,” the user can choose between counting the number of credits for that specific day of week (“Credits—<day>”), or counting the credits from all days marked as using fairness (“Credits—All”). Likewise, as noted above, the “Last Time Worked” option allows the user to indicate whether the sort algorithm should consider the last time the agent worked this day of the week, or the last time the agent worked any day which is marked as a fairness day. Further, the user can prioritize fairness days, which provides the system with a finer level of control over fairness-based scheduling. In particular, fairness days are processed in order of priority, and more than one day can have the same priority (in which case these days are processed together as a group). For each fairness priority value, the schedule generation process determines which agents will work the fairness days in that group and which agents will be scheduled off. When a subsequent priority value is being processed, the schedule generation process preferably does not alter the fairness assignments of fairness days with a higher priority.

As noted above, if a holiday date is marked as using fairness, then preferably day of week or weekend fairness will not be processed for this date. Thus, preferably the holiday fairness overrules the day of week or weekend fairness rotation. When determining whether agents worked a day of the week or weekend, if the date was a holiday which used fairness, then that date will not be considered to have been worked by the agent for the day of week or weekend fairness rotation.

As each agent receives a schedule, the fairness rotation for the remaining fairness days in the week is recalculated if the sort options for the remaining fairness days include selections that would change by nature of the agent being scheduled for a fairness day. For example, if Monday and Friday are considered fairness days, and the user has chosen “Credits—All” as an option for sorting agents for these days, then when an agent is scheduled to work on Monday of that week, then his/her position in the fairness rotation for Friday will change because the agent now has an additional credit for working Monday of this week. Preferably, the Seniority Date/Extension or Rank field is used as a final tie-breaker (depending on the user selection for preference granting) if other sort options do not result in a unique order of agent eligibility.

If the user has not selected the “fairness over coverage” option, despite the prioritization of fairness days and the knowledge of which agent's turn it is to work a fairness day, it may be more important to schedule an agent for another day. However, over a period of time, the fairness processing results in agents working approximately the same number of fairness days even though in the short-term it may appear that an agent should have been scheduled to work a fairness day. If the user has selected the “fairness over coverage” option, then the schedule generation process will ensure that an agent is scheduled for a fairness day in turn, even if another day of the week needs that agent more than this fairness day.

In particular, the scheduler's primary goal is to satisfy staffing requirements. Fairness scheduling makes allowances for agents who can provide coverage to periods with otherwise limited availability. For agents who are truly the only agents who can provide coverage for some periods, those agents may be occasionally excused from fairness assignments to accommodate the special coverage that they can provide. In turn, this means that on any given week, it is possible for agents to be scheduled for fairness when other agents apparently more eligible did not. This is normal for the short-term. In the long-term, though, it should balance out, because those agents who were eligible for fairness but were needed elsewhere more urgently will move to the front of the eligibility list on the following week. With the addition of the “fairness over coverage” option for fairness days, a fairness day can be marked to have priority over staffing, eliminating the possibility that a non-fairness day could make an agent unavailable for the fairness days marked as having priority over coverage.

There is also the possibility that agents will be excused from fairness on one day to be able to schedule them for fairness on another day. This is a slightly different situation than above in that the scheduler must decide between violating fairness between two independent fairness days rather than making the decision to cover a non-fairness day instead of assigning an agent to a fairness day. In this case, the decision essentially goes to the day that needed the agent for coverage first. Again, in the short term, it may appear as though agents are being scheduled out of fairness order, but in the long-term, agents will be assigned about the same number of times as all other agents to each fairness day. With the addition of the new priority values for fairness days, this can be resolved by prioritizing the fairness days, although it cannot be prevented among fairness days at the same priority.

Holiday fairness is processed in the same way as day of week fairness. In particular, fairness records are reviewed in conjunction with the fairness options as set on the display tab to determine which agents are most eligible to work a holiday date that uses fairness. If more than one holiday date falls within a scheduling week, as each agent receives a holiday schedule, the fairness rotation for the remaining holiday days in the week is recalculated if the sort options for the remaining holiday days include selections that would change by nature of the agent being scheduled for a holiday day. For example, if Thanksgiving Day and Thanksgiving Friday are considered holidays, and the user has chosen “Credits—All” as an option for sorting agents for these days, then when an agent is scheduled to work on Thanksgiving Day of that week, his/her position in the fairness rotation for Thanksgiving Friday will change because the agent now has an additional credit for working Thanksgiving Day of this week. The Bidding Date/Extension is preferably used as a final tie-breaker if other sort options do not result in a unique order of agent eligibility.

The invention may be extended to provide additional functionality. Thus, it may be desirable to provide a display screen that would allow a supervisor to view/edit the agent holiday preferences. The system would then be enhanced to allow an option that would view each holiday date as a required day for agents, where each agent must either work, or be given an all day exception indicating that the agent is off. Fairness rotation then would be used to determine which agents worked on the holiday, and then once enough agents were scheduled, all agents would receive a schedule with a user-specified exception applied to the entire day. In this case, all agents who could work on that day (based on a tour group definition, which typically is a set of weekly work rules defining which days an agent can work, and which days an agent must work) would receive a schedule for that day (and the day would count toward the tour group min/max days). Typically, the system requires the user (the administrator) to assign agents to tour groups that do not require them to work so that the schedule generator can choose how many agents to schedule and simply not schedule agents who are not needed.

### Variants and Extensions

While the present invention has been described in the context of an embodiment wherein a display interface is used to implement the day of week or holiday fairness policy, this is not a requirement. The fairness policy may be implemented using any type of interface (e.g., a command line interface, a programmatic interface, a configuration file or the like).

Moreover, the requirement of “user-defined sort options” is not a limitation of the invention either. The options may be defined in any convenient manner, e.g., programmatically, or even coded directly into the system code, in whole or in part without any user interaction.

Further, there is no requirement that a “credit” or “credits” be maintained within the system to facilitate the fairness policies. Instead of counting credits, the system may simply parse historical schedules to determine when a given agent worked. Thus, basic schedule history data for a given agent should be construed to be equivalent to the “credit” or “historical credit” data referred to above.

According to another extension, it is not required that the system implement fairness processing tied to a given “day” or daily work period. Indeed, the techniques of the present invention may enable the definition and processing of a fairness policy tied to a given portion (e.g., morning, afternoon, or the like) of a given day or, at the other extreme, a policy tied to a period longer than a given day and/or spanning more than a given week (e.g., a “week of month,” “month of year,” “day of bimonthly pay period,” or other inter-day period). Fairness may involve a given time period (e.g., 2 hours) on a given day, or it may represent a given intra-day time period lasting across another inter-day time period (e.g., 2 weeks). Of course, the above are just representative examples. Moreover, a given “credit” associated with the fairness policy unit (whether a given day, an intra-day period, an inter-day period, as the case may be) may be assigned a given weight based, for example, on one of more factors, such as agent skill type, type of policy unit (day, intra-day, inter-day, etc.), and the like. Thus, there is no requirement that, for a given fairness policy, a credit always has the same value. Indeed, there may be many scenarios where it will be desired for credit(s) to have differing values and/or otherwise to be assigned in a weighted manner.

One of ordinary skill in the art will also appreciate that the day of week and holiday fairness processing described herein may be generalized to any “time off” (or other “non-work”) period, however designated by the workforce management organization. Thus, the techniques of the present invention are applicable to vacation scheduling systems.

In addition, one of ordinary skill will also appreciate that a given rank order of agent availability (that is provided to scheduler to enable schedule generation) may be based on factors other than just credits. In an alternative embodiment, a given rank order of agent availability may be applied through one or more other filters or processing, such as filters that take into consideration other data that is collected and available within the contact center environment. In particular, the contact center may include (or have access to) other systems such as an agent quality management system, a call flow analysis system, a customer survey system, an audio content based analysis system, a content management system, a knowledge-based management system, a performance based knowledge system, a circuit switch management system, a VoIP management system, a computer telephony management system, and the like. If desired, one of more of these other systems may be integrated with the fairness scheduling system of the present invention so that agent sorts are influenced by this additional data. Thus, for example, where a performance management system is integrated, the particular agent sort may be a composite of the fairness policy and given agent performance data. A method of sharing information within an enterprise is described in commonly-owned U.S. Publication No. 20060179064, the disclosure of which is incorporated herein by reference.

Preferably, the fairness processing herein is carried out with at least one least of the processing steps being performed in a computer.

While the above describes a particular order of operations performed by certain embodiments of the invention, it should be understood that such order is exemplary, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic.

The invention can take the form of an entirely hardware embodiment, an entirely software embodiment, or an embodiment containing both hardware and software elements. In one preferred embodiment, the initial layout and reflow algorithms are implemented in software executing in one or more server machines. Each server may have one or more processors. The invention (or portions thereof) may take the form of a computer program product accessible from a computer-usable or computer-readable medium providing program code for use by or in connection with a computer or any instruction execution system. A computer-usable or computer readable medium can be any device or apparatus that can include, store or communicate the program for use by or in connection with the instruction execution system, apparatus, or device. The medium can be an electronic, magnetic, optical, or the like. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

While given components of the system have been described separately, one of ordinary skill will appreciate that some of the functions may be combined or shared in given instructions, program sequences, code portions, and the like.

Having described our invention, what we now claim is as follows.

1. A workforce management method for use in an environment wherein agents may be scheduled to work on any day of a week, comprising:
defining an any day of the week fairness policy, wherein the any day of the week fairness policy is associated with one or more sort options that order agents (a) when there are not enough volunteers to meet a number of agents required to work, or (b) when there are more volunteers than there are agents needed to meet requirements;
comparing the any day of the week fairness policy with given data to generate a rank order of agent eligibility to fulfill a schedule for a given future date; and
providing the rank order of agent eligibility to a scheduler to enable generation of one or more schedules for the given future date;
wherein at least one of the steps is performed in a computer.

2. The method as described in claim 1 wherein the any day of the week fairness policy is defined using a display interface indexed by any day of the week.

3. The method as described in claim 1 wherein the given data is credit data.

4. The method as described in claim 3 wherein, for a given agent and for a given time period, the credit data includes a credit for a given day of the week identified in the any day of the week fairness policy that the given agent actually worked during the given time period, together with a credit for the given day of the week that the given agent is expected to work and that occurs within the given time period and prior to the given future date.

5. The method as described in claim 1 wherein, if there are more volunteers than there are agents needed to meet requirements for a given day of the week, the rank order of agent eligibility results in scheduling agents that have a highest seniority or rank.

6. The method as described in claim 1 wherein, if there are not enough volunteers to meet a number of agents required to work a given day of the week, the rank order of agent eligibility results in scheduling agents that have a lowest seniority or rank.

7. The method as described in claim 1 wherein the one or more sort options include an option that enables the any day of the week fairness policy to be a function of credits for a specific day of the week.

8. The method as described in claim 1 wherein the one or more sort options include an option that enables the any day of the week fairness policy to be a function of credits for all days of the week that have a day of the week fairness policy associated therewith.

9. The method as described in claim 1 wherein the one or more sort options include an option that enables the any day of the week fairness policy to be a function of credits for a last time worked for the specific day of the week.

10. The method as described in claim 1 wherein the one or more sort options enables the any day of the week fairness policy to be a function of one of: a bidding date, and a seniority date.

11. The method as described in claim 1 further including adjusting the rank order of agent eligibility provided to the scheduler as a given agent is assigned to a given schedule that includes a day of the week having an associated fairness policy that is impacted by the assignment.

12. The method as described in claim 1 wherein the any day of the week fairness policy is associated with a weekend day.

13. The method as described in claim 1 wherein the weekend day is one of: Saturday, Sunday, and Saturday-Sunday.

14. The method as described in claim 1 further including associating a first priority to a first day of the week that has a first fairness policy, and associated a second priority to a second day of the week that has a second fairness policy.

15. The method as described in claim 14 wherein the scheduler processes the first and second fairness policies according to the first and second priorities.

16. The method as described in claim 1 further including:
determining whether the given future date has a holiday fairness policy associated therewith; and
if the given future date has a holiday fairness policy associated therewith, overriding the any day of the week fairness policy with the holiday fairness policy.

17. A workforce management method for use in a contact center environment wherein contact center agents may be scheduled to work on any day of a week, comprising:
defining a fairness policy associated with a first day of the week, wherein the first day of the week is any day of a work week;
defining a fairness policy associated with a second day of the week;
associating a priority to at least one of the first and second days;
generating a first rank order of agent eligibility to fulfill a content center schedule for a given future date that occurs on the first day of the week;
generating a second rank order of agent eligibility to fulfill a content center schedule for a given future date that occurs on the second day of the week;
wherein the first and second rank orders are a function of the priority;
wherein at least one of the steps is performed in a computer.

18. A workforce management method for use in a contact center environment wherein contact center agents may be scheduled to work on a holiday, comprising:
defining a holiday fairness policy, wherein the holiday fairness policy is associated with one or more sort options that order agents (a) when there are not enough volunteers to meet a number of agents required to work, or (b) when there are more volunteers than there are agents needed to meet requirements;
comparing the holiday fairness policy with given data to generate a rank order of agent eligibility to fulfill a contact center schedule for a given holiday date; and
providing the rank order of agent eligibility to a scheduler to enable generation of one or more contact center schedules for the given holiday date;
wherein at least one step is performed in a computer.

19. The method as described in claim 18 wherein the holiday fairness policy is defined using a display interface indexed by a given user-selected holiday.

20. The method as described in claim 18 wherein the given data is credit data.

21. The method as described in claim 20 wherein, for a given agent and for a given time period, the credit data includes a credit for the given holiday date identified in the holiday fairness policy that the given agent actually worked during the given time period.

22. The method as described in claim 18 wherein, if there are more volunteers than there are agents needed to meet requirements for the given holiday date, the rank order of agent eligibility results in scheduling agents that have a highest seniority or rank.

23. The method as described in claim 8 wherein, if there are not enough volunteers to meet a number of agents required to work the given holiday date, the rank order of agent eligibility results in scheduling agents that have a lowest seniority or rank.

24. The method as described in claim 18 wherein the one or more sort options include an option that enables the holiday fairness policy to be a function of credits for a particular history type.

25. The method as described in claim 18 wherein the one or more sort options include an option that enables the holiday fairness policy to be a function of credits for all holiday credit data.

26. The method as described in claim 18 further including adjusting the rank order of agent eligibility provided to the scheduler as a given agent is assigned to a given schedule that includes the given holiday date having an associated holiday fairness policy that is impacted by the assignment.

27. The method as described in claim 18 further including:
determining whether the given holiday date also has a day of week fairness policy associated therewith; and
if the given holiday date also has a day of week fairness policy associated therewith, overriding the day of week fairness policy with the holiday fairness policy.

28. A method for use in a workforce environment, comprising:
defining a fairness policy, wherein the fairness policy is associated with a policy unit that is one of: a given day, a given holiday, a given period within a given day, and a given period extending across a set of days;
comparing the fairness policy with given data to generate a rank order of agent eligibility to fulfill a future contact center schedule; and
providing the rank order of agent eligibility to a scheduler to enable generation of one or more future schedules;
wherein at least one of the steps is performed in a computer.

29. The method as described in claim 28 wherein the given data is credit data.

30. The method as described in claim 29 wherein the credit data is weighted.

31. The method as described in claim 30 wherein a weight afforded to a given piece of credit data is a function of an agent skill.

32. The method as described in claim 30 wherein a weight afforded to a given piece of credit data is a function of given agent performance data.

33. A computer-readable medium having computer-executable instructions for performing the method steps of claim 28.

34. A server comprising a processor, and a computer-readable medium, the computer-readable medium having processor-executable instructions for performing the method steps of claim 28.
